(19) United States
(12) Patent Application Publication
(10) Pub. No.: US 2026/0081347 A1
(43) Pub. Date: Mar. 19, 2026

(54) AIRCRAFT THROUGH-THE-ROTOR BEYOND LINE OF SIGHT (BLOS) SATELLITE COMMUNICATION (SATCOM) SYSTEM

(71) Applicants: John Parsley, Fort Walton Beach, FL (US); David Felker, Fort Walton Beach, FL (US)

(72) Inventors: John Parsley, Fort Walton Beach, FL (US); David Felker, Fort Walton Beach, FL (US)

(21) Appl. No.: 18/889,557

(22) Filed: Sep. 19, 2024

(51) Int. Cl. H01Q 1/28; H01Q 1/00; H01Q 1/42; H01Q 3/04

(52) U.S. Cl. CPC H01Q 1/28; H01Q 1/005; H01Q 3/04; H01Q 1/42

(57) ABSTRACT

An aircraft through-the-rotor beyond line of sight (BLOS) satellite communication (SATCOM) system may include a access panel frame. An aircraft through-the-rotor beyond line of sight (BLOS) satellite communication (SATCOM) system may include at least one removable antenna mounting plate. An aircraft through-the-rotor beyond line of sight (BLOS) satellite communication (SATCOM) system may include an access panel door. An aircraft through-the-rotor beyond line of sight (BLOS) satellite communication (SATCOM) system may include a circumferential base connected to the access panel frame. An aircraft through-the-rotor beyond line of sight (BLOS) satellite communication (SATCOM) system may include an antenna compartment positioned on top of the circumferential base. An aircraft through-the-rotor beyond line of sight (BLOS) satellite communication (SATCOM) system may include a terminal mounting plate positioned proximal, and connected to, a modem mount.

### FIELD OF THE INVENTION

The present invention relates in general to an aircraft through-the-rotor beyond line of sight (BLOS) satellite communication (SATCOM) system, and more specifically to an aircraft through-the-rotor beyond line of sight (BLOS) satellite communication (SATCOM) system that accommodates different aircraft antenna and/or sensor configurations. The present invention relates to classifications B64C 27/04 Helicopters; B64C 1/36 Fuselages; Constructional features common to fuselages, wings, stabilizing surfaces or the like adapted to receive antennas or radomes; H01Q 1/42 Housings not intimately mechanically associated with radiating elements, e.g. radome.

### BACKGROUND OF THE INVENTION

The classical approach of permanently modifying the upper fuselage of aircraft to install a communications antenna limited installation of new systems and/or new antennae/sensor(s). As an answer to this limitation, the industry has adopted the “roll-on/roll-off” alternative approach in reducing the limitations of the installation of any new system(s). The “roll-on/roll-off” solution provides some relief by allowing users to transport and install the specific system they need based on mission requirements and remove it at mission completion. However, the “roll-on/roll-off” approach has limitations as the number of positions for temporary antennas on aircraft is very limited. Adding new or upgraded systems to an aircraft fuselage may be difficult. Previous installations of satellite communication systems have suffered from weight issues, location negatively impacting the aircraft, high cost, and excessive aircraft downtime. At times there may be issues with placement of the Satellite Communication System such that it is positioned beyond the rotor blades. As such, there is a need for an improved SATCOM antenna system that may be located or positioned at an optimal aircraft location without obscuring hemispherical visibility, while overcoming the weight, cost, and downtime issues.

### SUMMARY OF THE INVENTION

This invention introduces an aircraft through-the-rotor beyond line of sight (BLOS) satellite communication (SATCOM) system for installing multiple configurations of antennas which can be easily removed and installed to configure an aircraft for a specific mission. Aspects of embodiments of the present invention involve positioning of the contemplated system at an access panel mounted for S-70/H-60 aircraft. Aspects of embodiments of the present invention involve positioning of the contemplated system at an access panel mounted on the fuselage.

Positioning of the contemplated system is available by replacing the existing access door while allowing normal maintenance activities.

An aspect of an embodiment of the present invention contemplates an aircraft through-the-rotor beyond line of sight (BLOS) satellite communication (SATCOM) system that may be positioned/installed at the access door panel of an aircraft. The aircraft through-the-rotor beyond line of sight (BLOS) satellite communication (SATCOM) system may include a access panel frame, a circumferential base connected to the access panel frame, an antenna compartment positioned on top of the circumferential base, and a removable antenna mounting plate, and connected to, the antenna compartment.

In an aspect of an embodiment of the present invention, the aircraft through-the-rotor beyond line of sight (BLOS) satellite communication (SATCOM) system may include a covering structure, where the covering structure covers aircraft through-the-rotor beyond line of sight (BLOS) satellite communication (SATCOM) system and is connected to the circumferential base.

In an aspect of an embodiment of the present invention, the removable antenna mounting plate may be connected to the antenna compartment by one or more vertical connectors.

In an aspect of an embodiment of the present invention, the removable antenna mounting plate may be inclined or tilted at an angle. This, in one aspect, may be made possible by way of the one or more vertical connectors.

In an aspect of an embodiment of the present invention, the aircraft through-the-rotor beyond line of sight (BLOS) satellite communication (SATCOM) system may include one or more fenestrations or openings at the circumferential base, where the one or more fenestrations or openings enables electronic and electrical connections to antennas installed within the aircraft through-the-rotor beyond line of sight (BLOS) satellite communication (SATCOM) system.

In an aspect of an embodiment of the present invention, the access panel frame may be contoured to enable flush installation of the system onto an aircraft.

In an aspect of an embodiment of the present invention, the circumferential base may include a concentric arrangement of a pressure seal, seal retaining ring and a weather seal, where the pressure seal rings the circumference of the circumferential base, where the seal retaining ring is circumferentially positioned along the periphery of the pressure seal and where the weather seal is circumferentially positioned along an outer periphery of the circumferential base.

In an aspect of an embodiment of the present invention, the aircraft through-the-rotor beyond line of sight (BLOS) satellite communication (SATCOM) system may include a plurality of fasteners for fastening the access panel frame to pre-existing fastener holes on the aircraft.

Advantages of the contemplated invention include:
1. Reversibility. Because there are no permanent modifications required (no new holes) the installation is considered as “Temporary”. Reversible also means that the system can be removed, and the aircraft returned to its original configuration.
2. Adaptability/Upgrade Ability: Because the system is a temporary installation, system components can be replaced, upgraded, exchanged or removed at any time. The contemplated system can also accommodate many of the legacy Antenna and/or Sensor configurations. The antenna plate and radome may be re-configured or replaceable with customer defined hardware.

Location: The installed location of the system (i.e. the central superior portion of the aircraft) does not impact existing installed systems, does not impact basic aircraft aerodynamics, and has never been utilized except as an access panel.

No Aircraft Modification: Use of the contemplated system enables expansion of aircraft communication and data capability without modification of the aircraft.

Additional aspects, objectives, features and advantages of the present invention will become apparent from the following description of the preferred embodiments with reference to the attached drawings.

### BRIEF DESCRIPTION OF THE DRAWINGS

The features and advantages of aspects of the present invention will become more apparent from the detailed description set forth below when taken in conjunction with the claims and drawings, in which like reference numbers indicate identical or functionally similar elements.

FIG. 1 illustrates a perspective view of an aircraft fuselage to be utilized in the aircraft through-the-rotor beyond line of sight (BLOS) satellite communication (SATCOM) system according to an aspect of an embodiment of the present invention.

FIG. 2 illustrates a more detailed sectional perspective view of a pylon of an aircraft through-the-rotor beyond line of sight (BLOS) satellite communication (SATCOM) system according to an aspect of an embodiment of the present invention.

FIG. 3 illustrates a more detailed sectional perspective view of a main rotor pylon of an aircraft through-the-rotor beyond line of sight (BLOS) satellite communication (SATCOM) system according to an aspect of an embodiment of the present invention.

FIG. 4 illustrates a more detailed sectional perspective view of a frame for the access panel door of an aircraft through-the-rotor beyond line of sight (BLOS) satellite communication (SATCOM) system according to an aspect of an embodiment of the present invention.

FIG. 5 illustrates a more detailed sectional perspective view of antenna plates for an aircraft through-the-rotor beyond line of sight (BLOS) satellite communication (SATCOM) system according to an aspect of an embodiment of the present invention.

FIG. 6 illustrates a more detailed sectional perspective view of antenna plates, antenna mount, and satellite antenna for an aircraft through-the-rotor beyond line of sight (BLOS) satellite communication (SATCOM) system according to an aspect of an embodiment of the present invention.

FIG. 7 illustrates an exemplary embodiment of an aircraft through-the-rotor beyond line of sight (BLOS) satellite communication (SATCOM) system according to an aspect of an embodiment of the present invention.

FIG. 8 illustrates an exemplary embodiment of an aircraft through-the-rotor beyond line of sight (BLOS) satellite communication (SATCOM) system according to an aspect of an embodiment of the present invention.

FIG. 9 illustrates an exemplary embodiment of an aircraft through-the-rotor beyond line of sight (BLOS) satellite communication (SATCOM) system according to an aspect of an embodiment of the present invention.

FIGS. 10A, 10B, 10C, 10D, 10E, 10F illustrates an exemplary embodiment of an aircraft through-the-rotor beyond line of sight (BLOS) satellite communication (SATCOM) system according to an aspect of an embodiment of the present invention.

FIG. 11 illustrates an exemplary embodiment of an aircraft through-the-rotor beyond line of sight (BLOS) satellite communication (SATCOM) system without the satellite terminal attached according to an aspect of an embodiment of the present invention.

FIG. 12 illustrates an exemplary embodiment of the modem assembly mounted under the door of an aircraft through-the-rotor beyond line of sight (BLOS) satellite communication (SATCOM) system without the satellite terminal attached according to an aspect of an embodiment of the present invention.

FIG. 13 illustrates an exemplary embodiment of the modem assembly mounted under the door of an aircraft through-the-rotor beyond line of sight (BLOS) satellite communication (SATCOM) system without the satellite terminal attached according to an aspect of an embodiment of the present invention.

FIGS. 1400A, 1400B, and 1400C illustrate an exemplary embodiment of an aircraft through-the-rotor beyond line of sight (BLOS) satellite communication (SATCOM) system according to an aspect of an embodiment of the present invention.

### DETAILED DESCRIPTION OF THE INVENTION

In some aspects, the techniques described herein relate to an aircraft through-the-rotor beyond line of sight (BLOS), further including a FIG. 1 illustrates a perspective view of an aircraft fuselage to be utilized in the aircraft through-the-rotor beyond line of sight (BLOS) satellite communication (SATCOM) system according to an aspect of an embodiment of the present invention. Referring now to FIG. 1, a perspective view of an aircraft through-the-rotor beyond line of sight (BLOS) satellite communication (SATCOM) system is shown on aircraft according to an aspect of an embodiment of the present invention. Aircraft through-the-rotor beyond line of sight (BLOS) satellite communication (SATCOM) system This disclosure provides a methodology for converting an access door into a secure mount for a high frequency satellite antenna and additional opportunities for future upgrades for additional capabilities. FIG. 1 shows a section A (100) for the superior portion of the aircraft fuselage which houses the access door.

FIG. 2 illustrates a more detailed sectional perspective view of a pylon of an aircraft through-the-rotor beyond line of sight (BLOS) satellite communication (SATCOM) system according to an aspect of an embodiment of the present invention. More specifically, FIG. 2, shows a cross section A (100) for the superior portion of the aircraft fuselage which houses the access door 82. The location selected replaces the Fire Suppression Bottles Access Door (Item 82) shown in the accompanying figure. This door provides routine access to the Fire Suppression bottles.

There are two primary aspects of the modification design described herein. The first is the upgrade of the existing structure to allow it to support increased weight, maintain access for routine inspection and maintenance, and establish tight mechanical and dimensional parameters for the replaceable antenna panel.

The H-60 and it's civilian counterpart the S-70, exhibit a great deal of dimensional variability. Secondary structures (not primary airframe) such as access doors are all “trim to fit” or match-drill meaning drill new holes to match old holes. The Frame design and installation establishes a standard dimension for the Door making them interchangeable between aircraft.

FIG. 3 illustrates a more detailed sectional perspective view of a main rotor pylon 300 of an aircraft through-the-rotor beyond line of sight (BLOS) satellite communication (SATCOM) system according to an aspect of an embodiment of the present invention. The main rotor pylon comprises a main transmission fairing support 302, an engine firewall 304, an APU access door support 306, a fire bottles support 308, an oil cooler blower radiator support 310, an exhaust fairing 312, an oil cooler access door support 314.

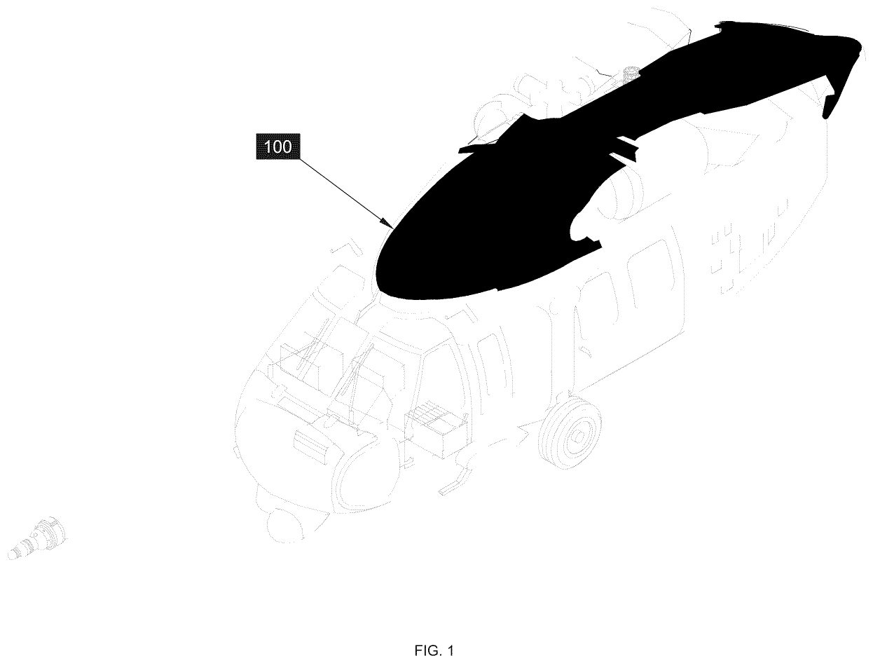

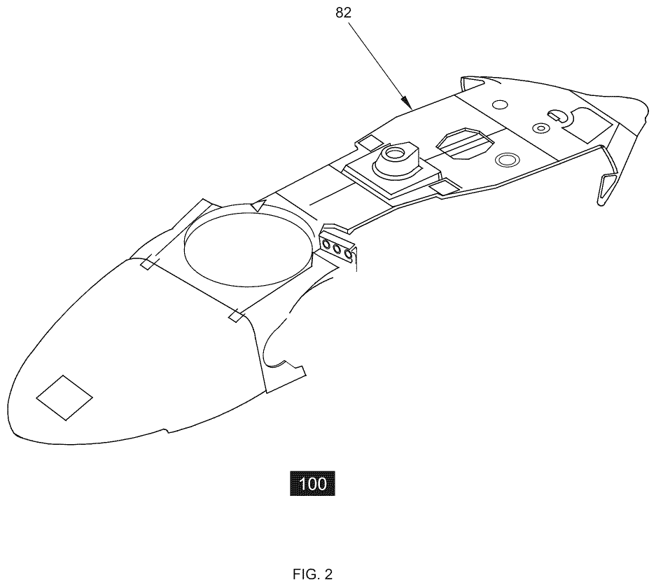

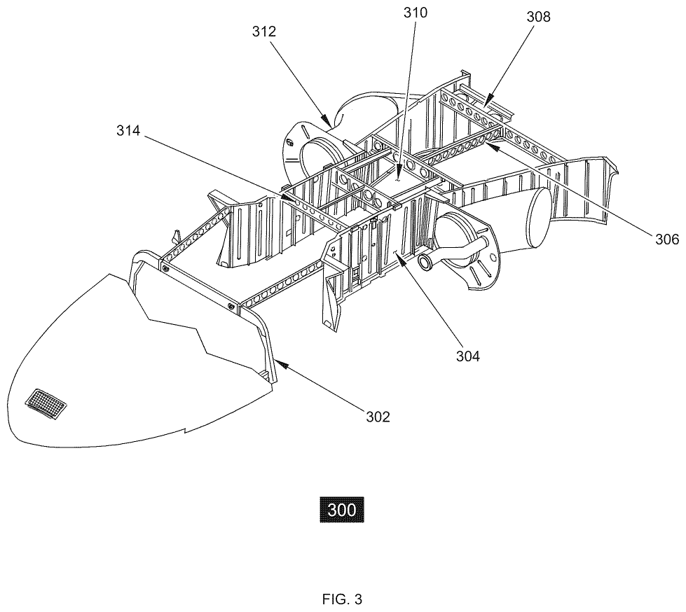

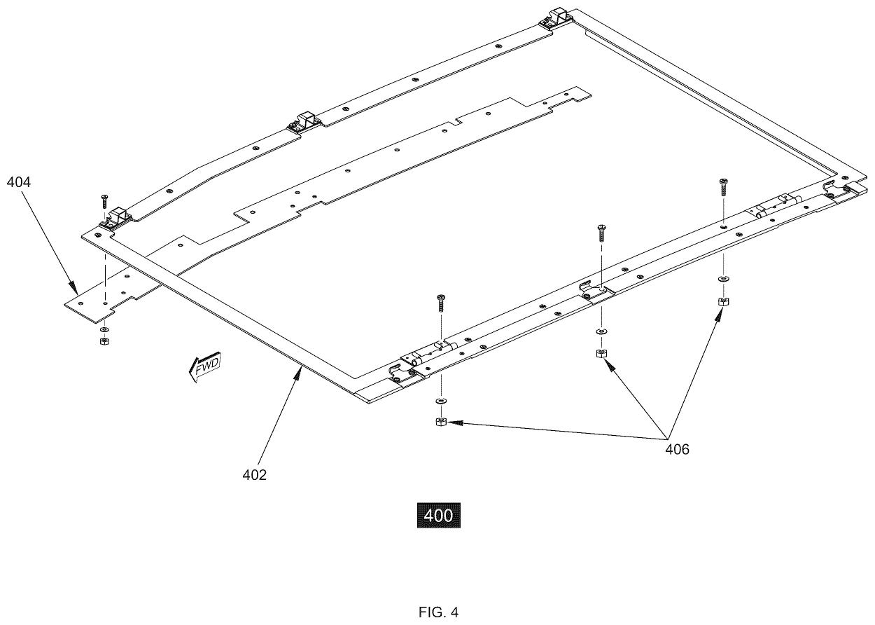

FIG. 4 illustrates a more detailed sectional perspective view of a frame assembly 400 for the access panel door of an aircraft through-the-rotor beyond line of sight (BLOS) satellite communication (SATCOM) system according to an aspect of an embodiment of the present invention.

The Frame assembly 400 includes the firewall reinforcement strap and the picture frame which includes quick release hinges and six (6) latch anchors as shown in 402, 404, and 406. These attributes allow the antenna panel to be installed and removed in just a few minutes without the need for hand tools. It also relocates the hinges to the centerline allowing maintenance personnel to open the panel safely by pushing it away from themselves instead of pulling it towards them.

The Picture Frame establishes accurate antenna panel (door) opening dimensions. The contour, hinge and latch locations and external dimensions of the Door are established by the Frame. Tight tolerances on these attributes means the door is no longer aircraft specific, allowing it to be moved between aircraft at will.

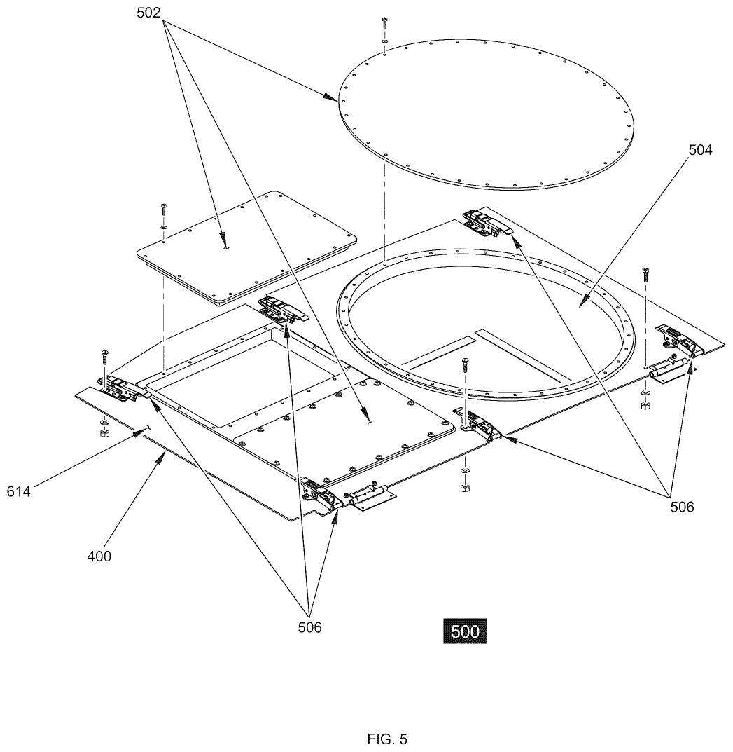

FIG. 5 illustrates a more detailed sectional perspective view of antenna plates assembly 500 for an aircraft through-the-rotor beyond line of sight (BLOS) satellite communication (SATCOM) system according to an aspect of an embodiment of the present invention. Antenna plates 502 are connected to access panel frame assembly 400. There is herein a circumferential base 504 which forms the connection point for additional components of access panel system 500. Positioned on top of or above circumferential base 504 is antenna compartment. Antenna plates assembly 500 further comprises an access panel door 614, and fasteners 506.

The Door 614 is an integrally stiffened panel which includes multiple antennae mounting plates 502, six (6) locking draw latches and hinge attachments 506. The vibration environment on the H-60/S-70 may be particularly harsh and unforgiving. The Frame and Door assembly 400 was specifically tuned to be unreactive to the vibration spectrum it is exposed to onboard the helicopter.

The antenna plates may be configured to be easily replaceable/modified to support installation of almost any antenna in the current inventory. Adding or subtracting an antenna is as simple as changing the antenna plate. Note that the Door can be removed and installed by unlatching the six (6) draw latches and releasing the quick-release hinges 506.

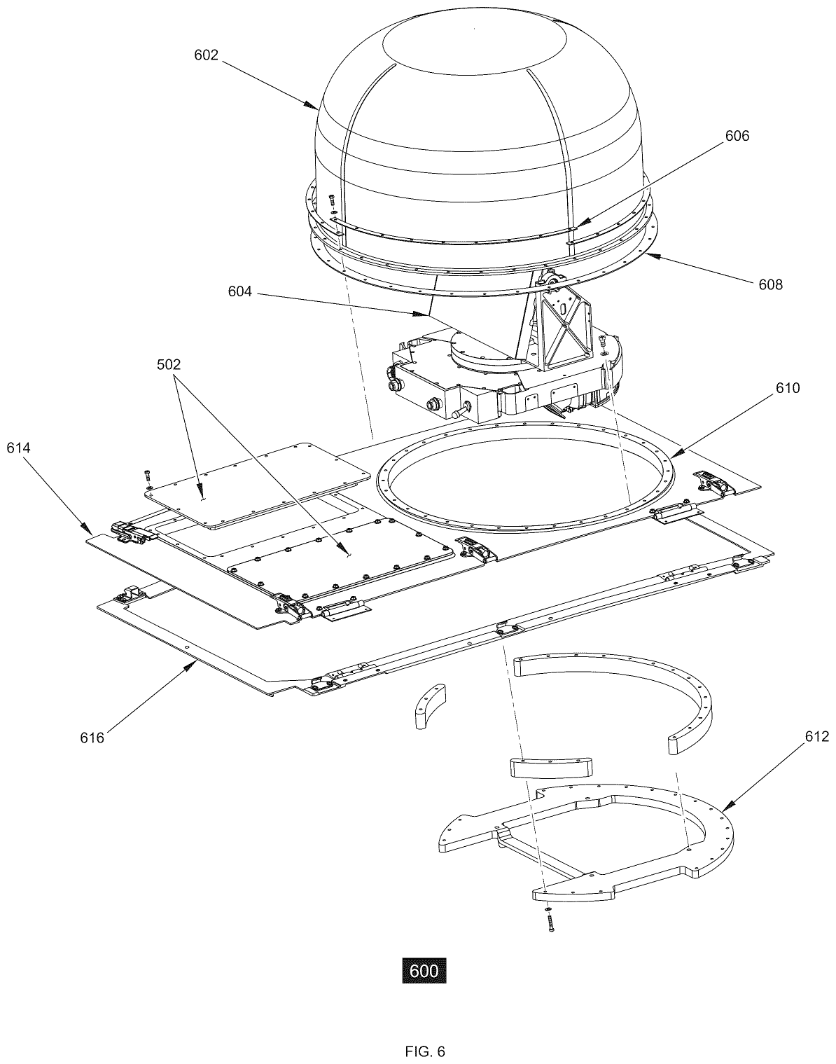

FIG. 6 illustrates a more detailed sectional perspective view of an antenna assembly 600 comprising antenna plates 502 (FIG. 5), antenna mount 612, and satellite antenna assembly for an aircraft through-the-rotor beyond line of sight (BLOS) satellite communication (SATCOM) system according to an aspect of an embodiment of the present invention. The antenna assembly 600 further comprises a radome 602, antenna 604, clamping ring 606, radome gasket 608, radome mounting plate 610, antenna mount 612, maintenance access door 614, and the finished frame assembly 616.

FIG. 6 shows the primary antenna plate replaced with a mount for a satellite antenna. The Antenna Mount 612 allows the antenna to be recessed below the Door to improve clearance with the rotor blades.

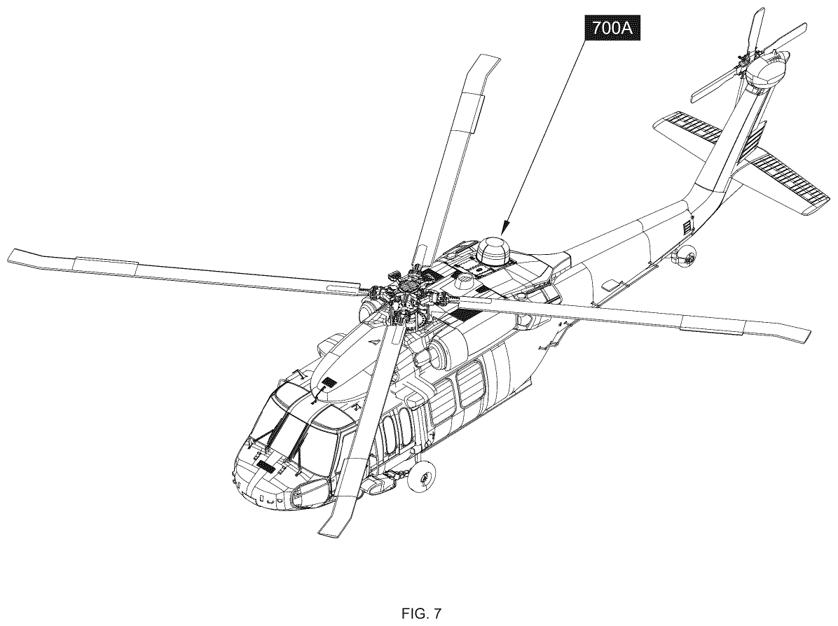

FIGS. 7, 700A illustrates an aircraft with a highlighted section A showing through-the-rotor beyond line of sight (BLOS) satellite communication (SATCOM) system according to an aspect of an embodiment of the present invention.

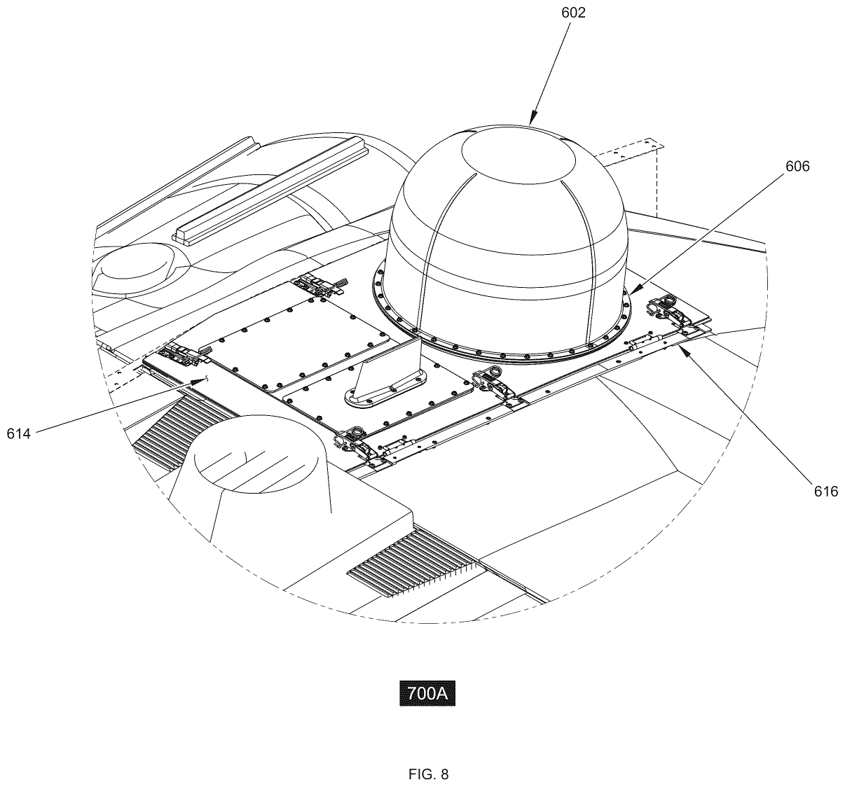

FIGS. 8, 700A illustrates the highlighted section A of the exemplary embodiment of an aircraft through-the-rotor beyond line of sight (BLOS) satellite communication (SATCOM) system according to an aspect of an embodiment of the present invention. FIG. 8 shows the antenna assembly 600 (FIG. 6) further comprises a radome 602, clamping ring 606, maintenance access door 614, and the finished frame assembly 616.

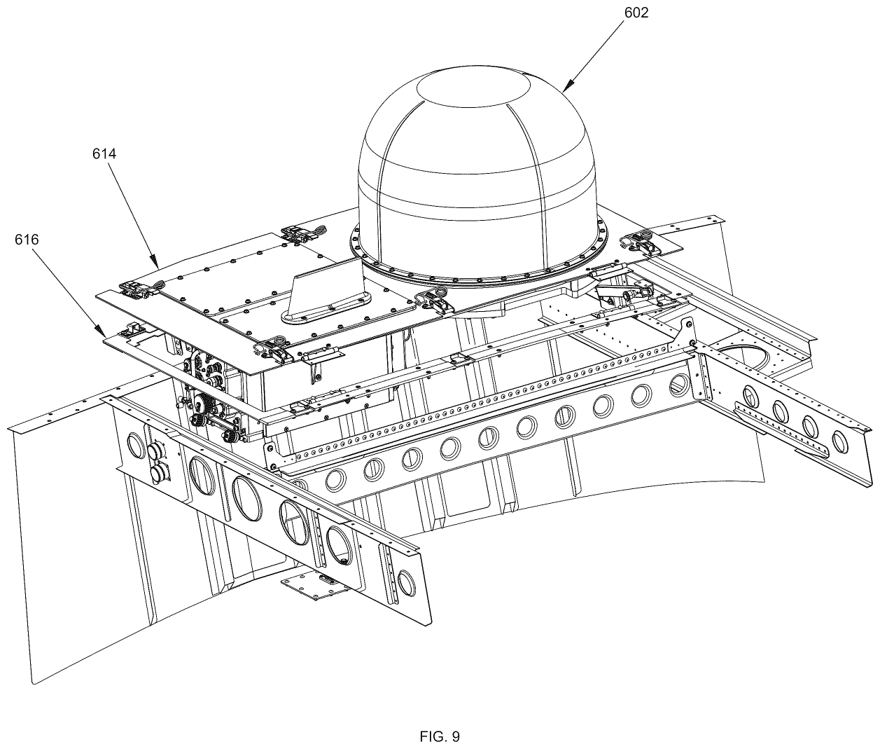

FIG. 9 illustrates an exemplary embodiment of an aircraft through-the-rotor beyond line of sight (BLOS) satellite communication (SATCOM) system according to an aspect of an embodiment of the present invention. FIG. 9 shows the antenna assembly 600 (FIG. 6) further comprises a radome 602, clamping ring 606 (FIG. 6), maintenance access door 614, and the finished frame assembly 616.

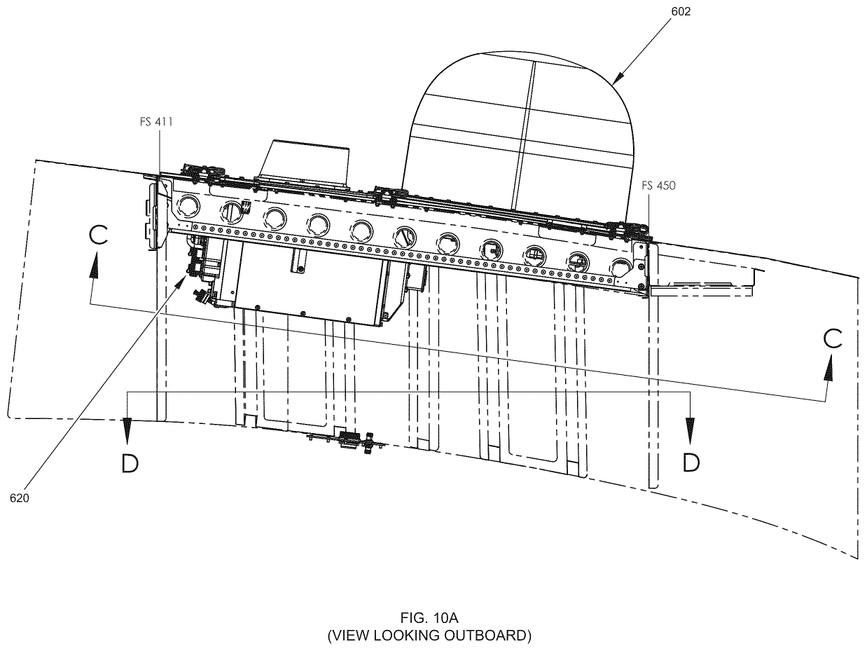

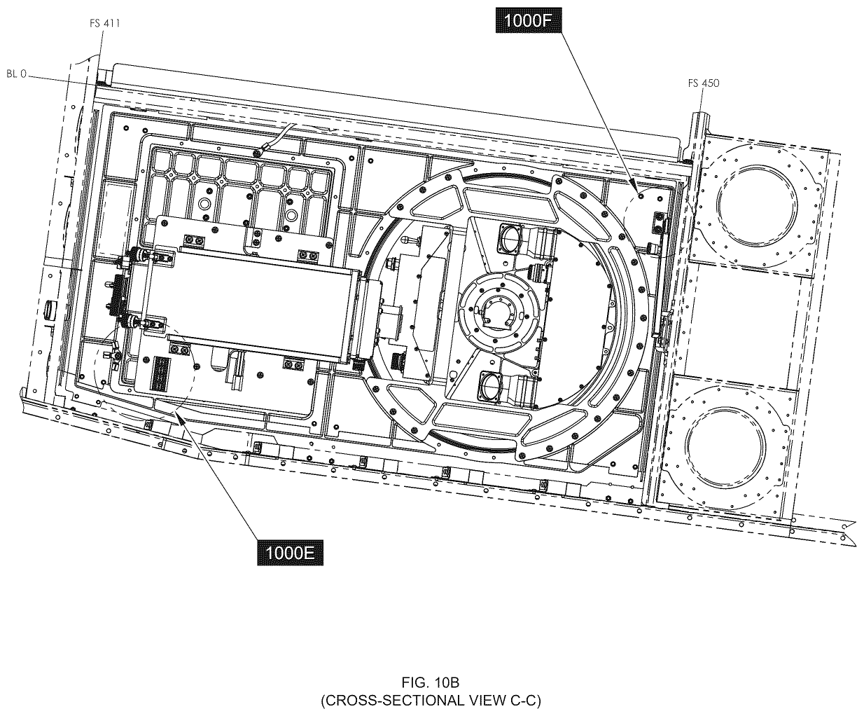

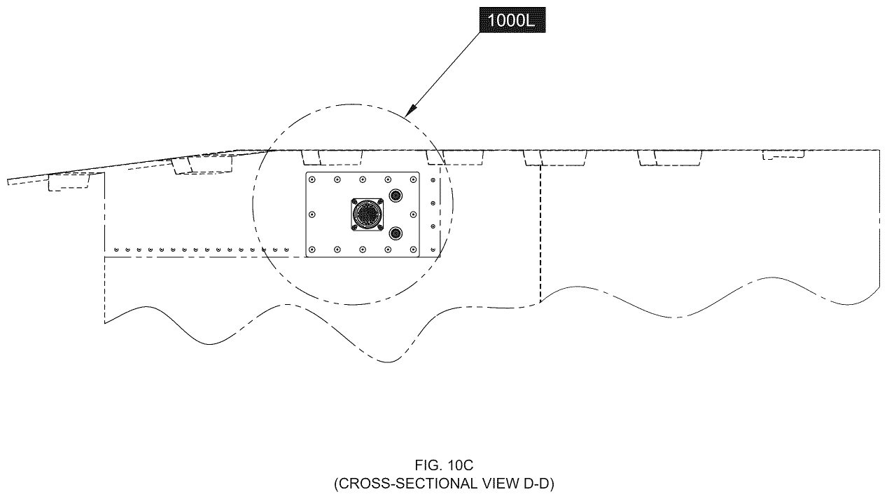

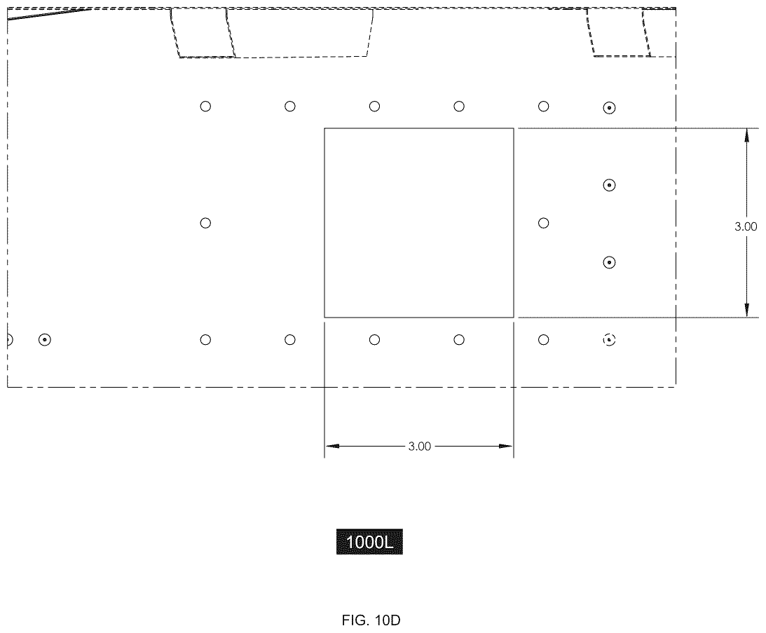

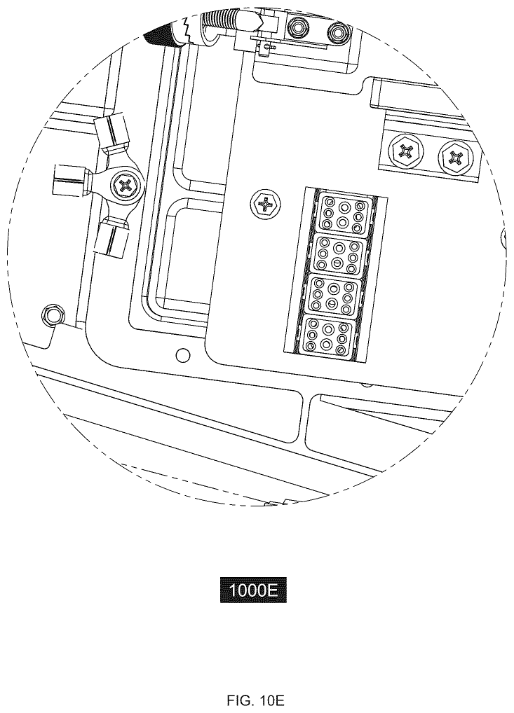

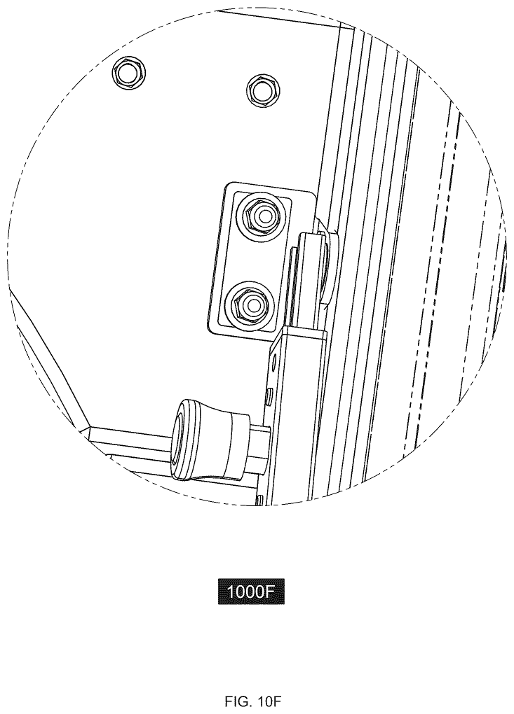

FIGS. 10A, 10B, 10C, 10D, 10E, 10F illustrates an exemplary embodiment of an aircraft through-the-rotor beyond line of sight (BLOS) satellite communication (SATCOM) system according to an aspect of an embodiment of the present invention. FIG. 10A shows a radome 602, a cable assembly 620, and sectional C and sectional D. FIG. 10B shows cross-sectional C-C and detailed highlighted area 1000F and 1000E. FIG. 10C shows cross-sectional D-D and detailed highlighted area 1000L. FIG. 10D shows detailed highlighted area 1000L. FIG. 10E shows cross-detailed highlighted area 1000E. 10F shows cross-detailed highlighted area 1000F.

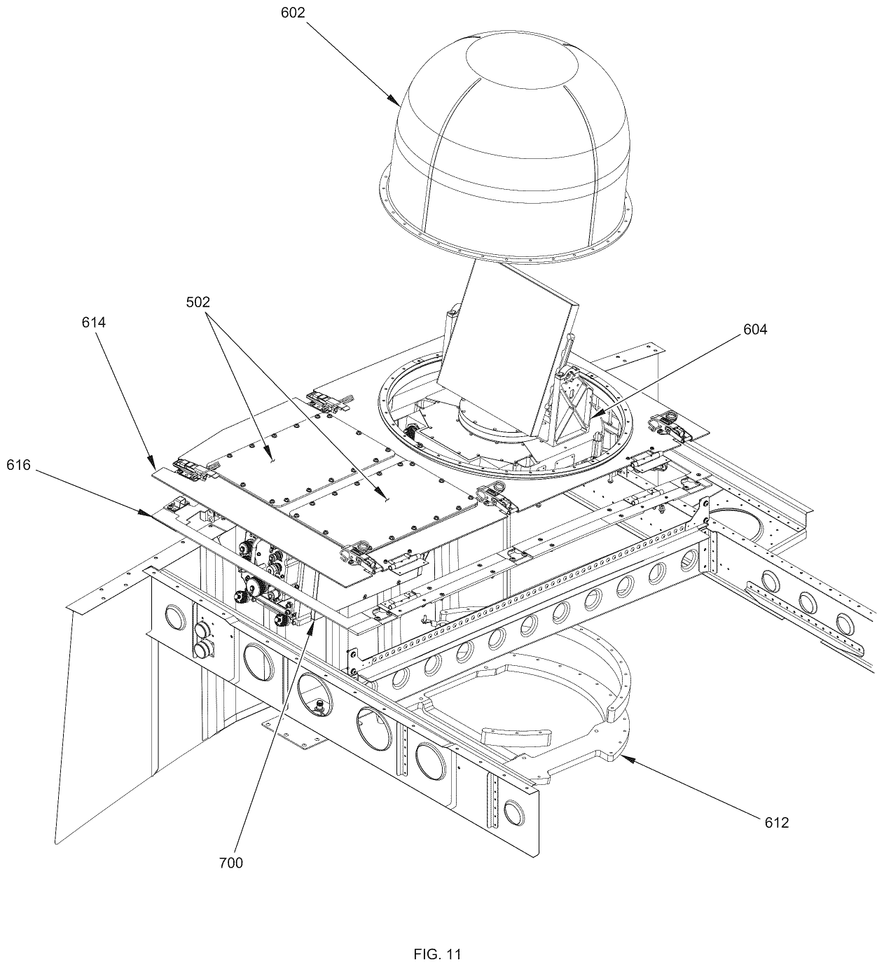

FIG. 11 illustrates an exemplary embodiment of an aircraft through-the-rotor beyond line of sight (BLOS) satellite communication (SATCOM) system without the satellite attached according to an aspect of an embodiment of the present invention. FIG. 11 shows the SATCOM door assembly with modem and antenna assembly. FIG. 11 shows the antenna plates 502, radome 602, antenna terminal 604, antenna mount or terminal mounting plate 612, modem mount 700, finished frame assembly 616, and access door 614.

In an aspect of an embodiment of the present invention, removable antenna mounting plate 612 may be connected to a radome mounting plate 612 or antenna compartment by one or more connectors. The one or more connectors may be configured to be positioned above, and connected to, antenna compartment in removable antenna mounting plate 612 which may be structurally configured to receive Ku/Ka Band antenna or similar antennae/sensor(s).

In an aspect of an embodiment of the present invention, aircraft through-the-rotor beyond line of sight (BLOS) satellite communication (SATCOM) system may include covering structure 602, where covering structure covers aircraft through-the-rotor beyond line of sight (BLOS) satellite communication (SATCOM) system and is connected to circumferential base 504 (FIG. 5).

In an aspect of an embodiment of the present invention, removable antenna mounting plate 612 may be inclined or tilted at an angle. This, in one aspect, may be made possible by way of the one or more connectors-which may, in another aspect of an embodiment of the present invention, have different heights to tilt antenna mounting plate 612.

In an aspect of an embodiment of the present invention, aircraft through-the-rotor beyond line of sight (BLOS) satellite communication (SATCOM) system may include one or more fenestrations or openings (not shown) at circumferential base 504 (FIG. 5), where the one or more fenestrations or openings may be used to channel electronic and electrical connections to antennas and/or power systems installed within aircraft through-the-rotor beyond line of sight (BLOS) satellite communication (SATCOM) system.

In an aspect of an embodiment of the present invention, circumferential base 504 (FIG. 5) may include a concentric arrangement of a pressure seal, seal retaining ring and a weather seal, where the pressure seal rings the circumference of circumferential base 504 (FIG. 5), where the seal retaining ring is circumferentially positioned along the periphery of the pressure seal and where the weather seal is circumferentially positioned along an outer periphery of circumferential base 504 (FIG. 5).

In an aspect of an embodiment of the present invention, aircraft through-the-rotor beyond line of sight (BLOS) satellite communication (SATCOM) system may include a plurality of fasteners for fastening frame 616 or 400 (FIG. 4) to pre-existing fastener holes on aircraft 100.

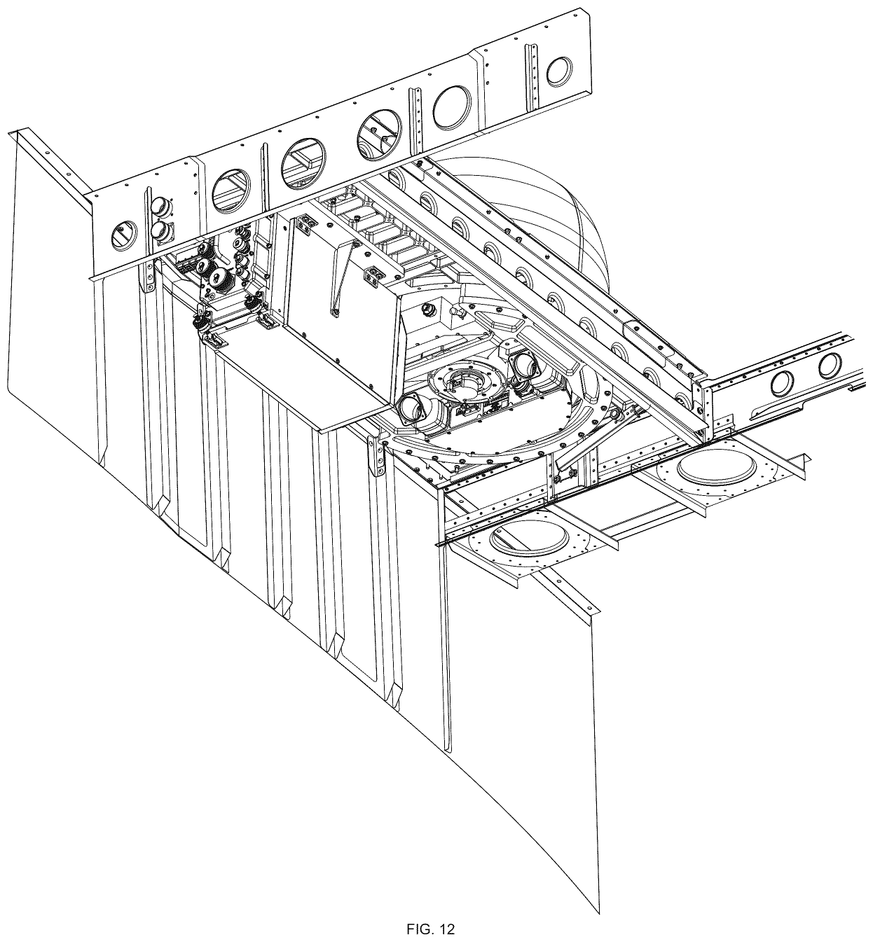

FIG. 12, illustrates an exemplary embodiment of the modem assembly mounted under the door of an aircraft through-the-rotor beyond line of sight (BLOS) satellite communication (SATCOM) system without the satellite terminal attached according to an aspect of an embodiment of the present invention.

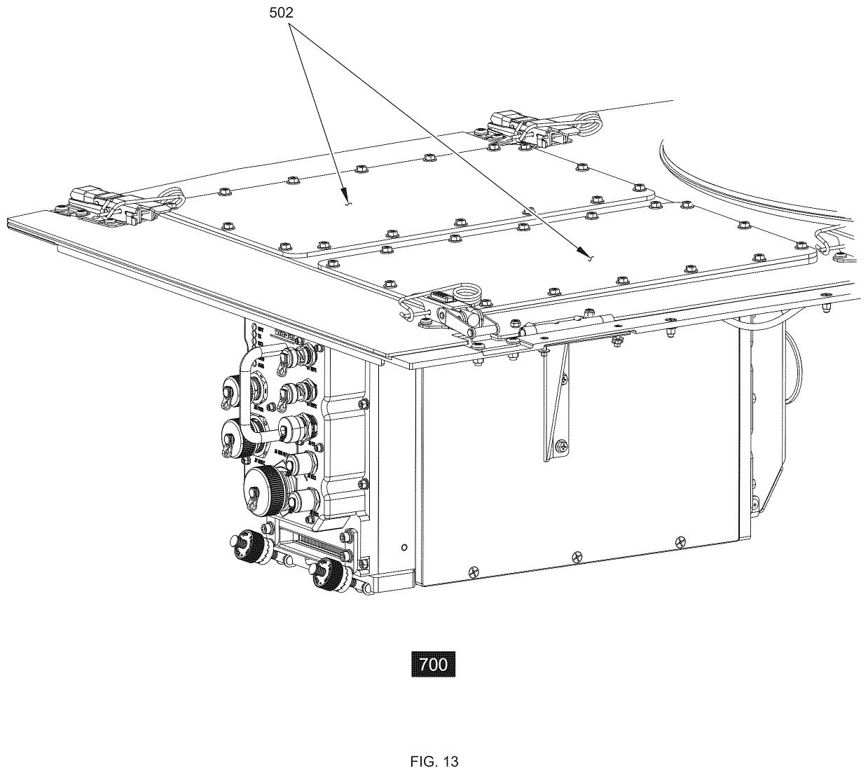

FIG. 13 illustrates an exemplary embodiment of the modem assembly mounted under the door, 502 and 700 of an aircraft through-the-rotor beyond line of sight (BLOS) satellite communication (SATCOM) system without the satellite attached according to an aspect of an embodiment of the present invention.

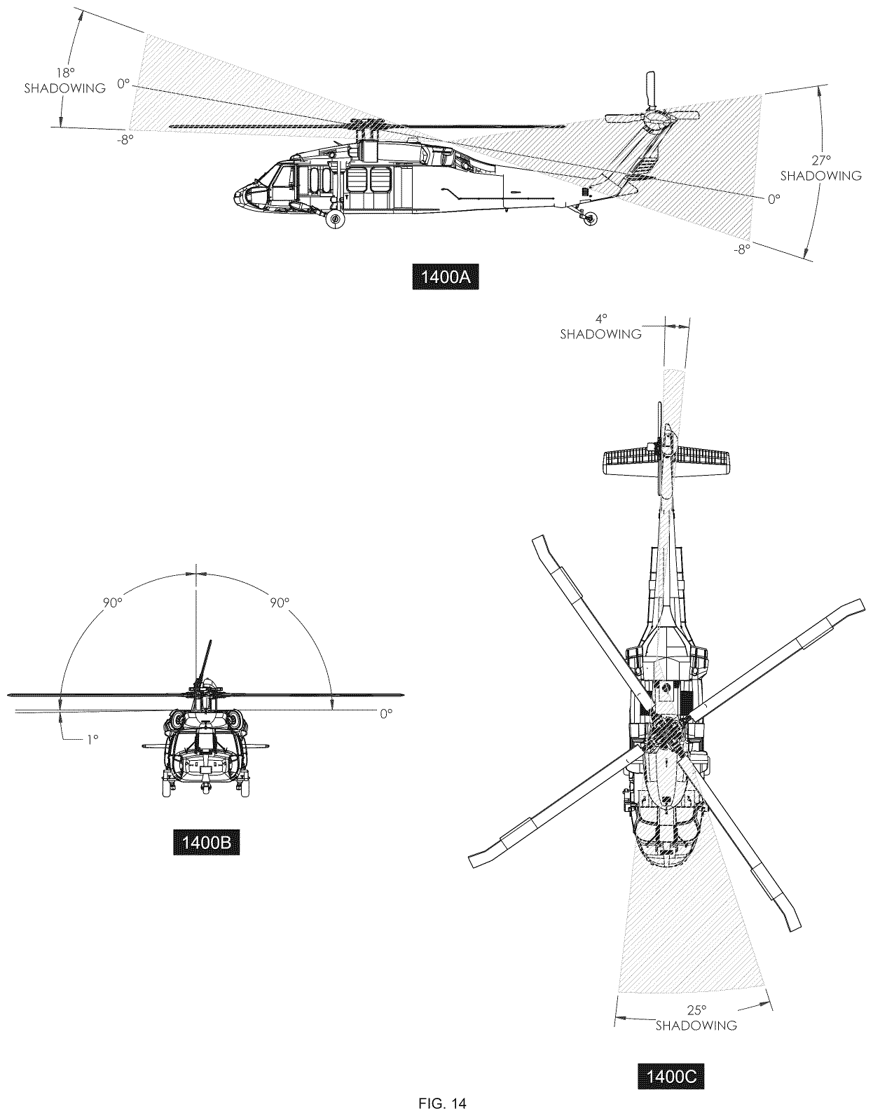

FIGS. 1400A, 1400B, and 1400C illustrate an exemplary embodiment of an aircraft through-the-rotor beyond line of sight (BLOS) satellite communication (SATCOM) system according to an aspect of an embodiment of the present invention.

In some aspects, the techniques described herein relate to an aircraft through-the-rotor beyond line of sight (BLOS) satellite communication (SATCOM) system, including: a access panel frame; at least one removable antenna mounting plate; an access panel door; a circumferential base connected to the access panel frame; an antenna compartment positioned on top of the circumferential base; and a terminal mounting plate positioned proximal, and connected to, a modem mount.

In some aspects, the techniques described herein relate to an aircraft through-the-rotor beyond line of sight (BLOS) satellite communication (SATCOM) system, including: a access panel frame; at least one removable antenna mounting plate; an access panel door; a circumferential base connected to the access panel frame; an antenna compartment positioned on top of the circumferential base; and a terminal mounting plate positioned proximal, and connected to, a modem mount. In some aspects, the techniques described herein relate to an aircraft through-the-rotor beyond line of sight (BLOS), further including

Clause 1. An aircraft through-the-rotor beyond line of sight (BLOS) satellite communication (SATCOM) system, including: a access panel frame; at least one removable antenna mounting plate; an access panel door; a circumferential base connected to the access panel frame; an antenna compartment positioned on top of the circumferential base; and a terminal mounting plate positioned proximal, and connected to, a modem mount.

Clause 2. The aircraft through-the-rotor beyond line of sight (BLOS) satellite communication (SATCOM) system of clause 1, further including a covering structure, wherein the covering structure covers the aircraft through-the-rotor beyond line of sight (BLOS) satellite communication (SATCOM) system and is connected to the circumferential base.

Clause 3. The aircraft through-the-rotor beyond line of sight (BLOS) satellite communication (SATCOM) system of clause 1, wherein the removable antenna mounting plate is connected to the antenna compartment by at least one additional connector.

Clause 4. The aircraft through-the-rotor beyond line of sight (BLOS) satellite communication (SATCOM) system of clause 1, wherein the removable antenna mounting plate is a radome.

Clause 5. The aircraft through-the-rotor beyond line of sight (BLOS) satellite communication (SATCOM) system of clause 1, wherein the removable antenna mounting plate is inclined at an angle.

Clause 6. The aircraft through-the-rotor beyond line of sight (BLOS) satellite communication (SATCOM) system of clause 1, further including at least one fenestration at the circumferential base, wherein the at least one fenestration enables electronic and electrical connections to antennas installed within the aircraft through-the-rotor beyond line of sight (BLOS) satellite communication (SATCOM) system.

Clause 7. The aircraft through-the-rotor beyond line of sight (BLOS) satellite communication (SATCOM) system of clause 1, wherein the access panel frame is contoured to enable flush installation of the system on an aircraft.

Clause 8. The aircraft through-the-rotor beyond line of sight (BLOS) satellite communication (SATCOM) system of clause 1, wherein the circumferential base includes of a concentric arrangement of a pressure seal, seal retaining ring and a weather seal, wherein the pressure seal rings the circumference of the circumferential base, wherein the seal retaining ring is circumferentially positioned along the periphery of the pressure seal and wherein the weather seal is circumferentially positioned along an outer periphery of the circumferential base.

Clause 9. The aircraft through-the-rotor beyond line of sight (BLOS) satellite communication (SATCOM) system of clause 1, further including a plurality of fasteners for fastening the access panel frame to pre-existing fastener holes on the aircraft.

Clause 10. The aircraft through-the-rotor beyond line of sight (BLOS) satellite communication (SATCOM) system of clause 1, further including a plurality of fasteners for fastening the access panel frame to pre-existing fastener holes on the aircraft via one or more mounting brackets and center beam of aircraft fuselage.

Clause 11. The aircraft through-the-rotor beyond line of sight (BLOS) satellite communication (SATCOM) system of clause 1, where the access panel door replaces a pre-existing maintenance access door.

Clause 12. The aircraft through-the-rotor beyond line of sight (BLOS) satellite communication (SATCOM) system of clause 1, where the aircraft is modified to accept the access panel door configured to replace a pre-existing maintenance access door.

Clause 13. The aircraft through-the-rotor beyond line of sight (BLOS) satellite communication (SATCOM) system of clause 1, where the satellite communication system is configured to be positioned to maximize antenna view angles with minimal obstructions from aircraft fuselage covering structure, wherein the covering structure covers the aircraft through-the-rotor beyond line of sight (BLOS) satellite communication (SATCOM) system and is connected to the circumferential base. In some aspects, the techniques described herein relate to an aircraft through-the-rotor beyond line of sight (BLOS), wherein the removable antenna mounting plate is connected to the antenna compartment by at least one additional connector. In some aspects, the techniques described herein relate to an aircraft through-the-rotor beyond line of sight (BLOS), wherein the removable antenna mounting plate is a radome. In some aspects, the techniques described herein relate to an aircraft through-the-rotor beyond line of sight (BLOS), wherein the removable antenna mounting plate is inclined at an angle. In some aspects, the techniques described herein relate to an aircraft through-the-rotor beyond line of sight (BLOS), further including at least one fenestration at the circumferential base, wherein the at least one fenestration enables electronic and electrical connections to antennas installed within the aircraft through-the-rotor beyond line of sight (BLOS) satellite communication (SATCOM) system. In some aspects, the techniques described herein relate to an aircraft through-the-rotor beyond line of sight (BLOS), wherein the access panel frame is contoured to enable flush installation of the system on an aircraft. In some aspects, the techniques described herein relate to an aircraft through-the-rotor beyond line of sight, wherein the circumferential base includes of a concentric arrangement of a pressure seal, seal retaining ring and a weather seal, wherein the pressure seal rings the circumference of the circumferential base, wherein the seal retaining ring is circumferentially positioned along the periphery of the pressure seal and wherein the weather seal is circumferentially positioned along an outer periphery of the circumferential base. In some aspects, the techniques described herein relate to an aircraft through-the-rotor beyond line of sight (BLOS), further including a plurality of fasteners for fastening the access panel frame to pre-existing fastener holes on the aircraft. In some aspects, the techniques described herein relate to an aircraft through-the-rotor beyond line of sight (BLOS), further including a plurality of fasteners for fastening the access panel frame to pre-existing fastener holes on the aircraft via one or more mounting brackets and center beam of aircraft fuselage. In some aspects, the techniques described herein relate to an aircraft through-the-rotor beyond line of sight, where the access panel door replaces a pre-existing maintenance access door. In some aspects, the techniques described herein relate to an aircraft through-the-rotor beyond line of sight, where the aircraft is modified to accept the access panel door configured to replace a pre-existing maintenance access door. In some aspects, the techniques described herein relate to an aircraft through-the-rotor beyond line of sight, where the satellite communication system is configured to be positioned to maximize antenna view angles with minimal obstructions from aircraft fuselage.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as defined in the appended claims.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application

What is claimed is:

1. An aircraft through-the-rotor beyond line of sight (BLOS) satellite communication (SATCOM) system, comprising:
an access panel frame;
at least one removable antenna mounting plate;
an access panel door;
a circumferential base connected to the access panel frame;
an antenna compartment positioned on top of the circumferential base; and
a terminal mounting plate positioned proximal, and connected to, a modem mount.

2. The aircraft through-the-rotor beyond line of sight (BLOS) satellite communication (SATCOM) system of claim 1, further comprising a covering structure, wherein the covering structure covers the aircraft through-the-rotor beyond line of sight (BLOS) satellite communication (SATCOM) system and is connected to the circumferential base.

3. The aircraft through-the-rotor beyond line of sight (BLOS) satellite communication (SATCOM) system of claim 1, wherein the removable antenna mounting plate is connected to the antenna compartment by at least one additional connector.

4. The aircraft through-the-rotor beyond line of sight (BLOS) satellite communication (SATCOM) system of claim 1, wherein the removable antenna mounting plate is a radome.

5. The aircraft through-the-rotor beyond line of sight (BLOS) satellite communication (SATCOM) system of claim 1, wherein the removable antenna mounting plate is inclined at an angle.

6. The aircraft through-the-rotor beyond line of sight (BLOS) satellite communication (SATCOM) system of claim 1, further comprising at least one fenestration at the circumferential base, wherein the at least one fenestration enables electronic and electrical connections to antennas installed within the aircraft through-the-rotor beyond line of sight (BLOS) satellite communication (SATCOM) system.

7. The aircraft through-the-rotor beyond line of sight (BLOS) satellite communication (SATCOM) system of claim 1, wherein the access panel frame is contoured to enable flush installation of the system on an aircraft.

8. The aircraft through-the-rotor beyond line of sight (BLOS) satellite communication (SATCOM) system of claim 1, wherein the circumferential base comprises of a concentric arrangement of a pressure seal, seal retaining ring and a weather seal, wherein the pressure seal rings the circumference of the circumferential base, wherein the seal retaining ring is circumferentially positioned along the periphery of the pressure seal and wherein the weather seal is circumferentially positioned along an outer periphery of the circumferential base.

9. The aircraft through-the-rotor beyond line of sight (BLOS) satellite communication (SATCOM) system of claim 1, further comprising a plurality of fasteners for fastening the access panel frame to pre-existing fastener holes on the aircraft.

10. The aircraft through-the-rotor beyond line of sight (BLOS) satellite communication (SATCOM) system of claim 1, further comprising a plurality of fasteners for fastening the access panel frame to pre-existing fastener holes on the aircraft via one or more mounting brackets and center beam of aircraft fuselage.

11. The aircraft through-the-rotor beyond line of sight (BLOS) satellite communication (SATCOM) system of claim 1, where the access panel door replaces a pre-existing maintenance access door.

12. The aircraft through-the-rotor beyond line of sight (BLOS) satellite communication (SATCOM) system of claim 1, where the aircraft is modified to accept the access panel door configured to replace a pre-existing maintenance access door.

13. The aircraft through-the-rotor beyond line of sight (BLOS) satellite communication (SATCOM) system of claim 1, where the satellite communication system is configured to be positioned to maximize antenna view angles with minimal obstructions from aircraft fuselage.

14. A method of installing a satellite communication system on an aircraft, the method comprising:
providing a frame assembly configured to replace an existing access door on the aircraft;
mounting the frame assembly to an aircraft structure;
providing an antenna panel configured to attach to the frame assembly;
attaching at least one antenna mounting plate to the antenna panel;
installing at least one antenna on the at least one antenna mounting plate; and
securing the antenna panel to the frame assembly.

15. The method of claim 14, wherein mounting the frame assembly comprises:
reinforcing an existing structure of the aircraft to support increased weight;
installing a firewall reinforcement strap; and
attaching a picture frame comprising quick release hinges and latch anchors.

16. The method of claim 14, further comprising:
wherein the antenna panel comprises an integrally stiffened panel structure;
tuning the frame assembly and antenna panel to resist a vibration spectrum specific to the aircraft;
wherein securing the antenna panel comprises:
engaging a plurality of locking draw latches; and
connecting quick-release hinges.

17. The method of claim 14, the method comprising:
activating an antenna mounted on an antenna panel, wherein the antenna panel is secured to a frame assembly replacing an existing access door on the aircraft;
transmitting signals from the antenna through rotor blades of the aircraft to a satellite; and
receiving signals at the antenna from the satellite through the rotor blades of the aircraft.

18. The method of claim 17, further comprising:
adjusting an azimuth and elevation of the antenna for optimal satellite tracking;
performing automatic skew control for linear polarization of the antenna;
processing outgoing data for transmission using a modem mounted proximate to the antenna panel; and
monitoring signal strength and quality metrics to optimize performance of the satellite communication system.

19. A method of maintaining a satellite communication system on an aircraft, the method comprising:
accessing an antenna panel secured to a frame assembly, wherein the frame assembly replaces an existing access door on the aircraft;
releasing a plurality of locking draw latches securing the antenna panel to the frame assembly;
disconnecting quick-release hinges attaching the antenna panel to the frame assembly;
removing the antenna panel from the frame assembly;
performing maintenance on components within the frame assembly; and
re-securing the antenna panel to the frame assembly.
